(19) United States
(12) Patent Application Publication
(10) Pub. No.: US 2018/0163067 A1
(43) Pub. Date: Jun. 14, 2018

(54) INK COMPOSITION, USE OF SAME, AND PRINTED PRODUCT

(71) Applicant: GIESECKE+DEVRIENT CURRENCY TECHNOLOGY GMBH, München (DE)

(72) Inventors: Johann KECHT, München (DE); Axel SCHLOSSBAUER, München (DE)

(21) Appl. No.: 15/576,591

(22) PCT Filed: May 24, 2016
(86) PCT No.: PCT/EP2016/000856

§ 371 Date: Nov. 22, 2017

(30) Foreign Application Priority Data
May 26, 2015 (DE) 10 2015 006 753.2

(51) Int. Cl. C09D 11/38; C09D 11/50; C09K 11/06

(52) U.S. Cl. CPC C09D 11/38; C09K 2211/182; C09K 11/06; C09D 11/50

(57) ABSTRACT

An ink composition which is suitable for inkjet printing, comprises 0.001 wt.-% to 15 wt.-% of a rare earth complex of the formula, in which ‘Ln’ represents one or more trivalent rare earth cations chosen from the group consisting of Ce, Pr, Nd, Sm, Eu, Gd, Tb, Dy, Ho, Er, Tm, and Yb, preferably chosen from the group consisting of Eu, Gd, and Tb, ‘n’ is preferably three, ‘S’ is a C₅-C₆ heteroaryl, preferably a pyridyl, ‘Y’ is a diaza heterocycle, preferably an imidazolyl, particularly preferably a functionalized benzimidazolyl, ‘Z’ is either hydrogen or a functional group chosen from the group consisting of alkyl, aryl, sulfonyl, and halogen, ‘x’=1 or any desired natural number.

The invention relates to an ink composition, a use of the same and a printed product printed with the ink composition.

The invention relates in particular to red or green luminescent metal complexes, as well as an inkjet ink containing these metal complexes, which is characterized by a particularly high light stability of the metal complex. The complexes have suitable solubilities to be employed in common inkjet solvents.

Suitable (red luminescent) europium complexes with certain functional groups are described in “Bünzli et al., Inorg. Chem. 2009, vol. 48, pages 5611-5613”, see the following formula:

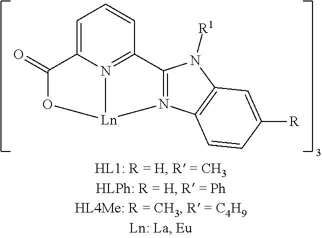

The general application of europium compounds in security inks is mentioned in the introduction, as well as the lack of light stability of certain other Eu-complex compounds. However no light stable ink composition suitable for inkjets is described that contains the complex.

Luminescent inkjet inks based on rare earth chelates are generally known.

For example, DE 60201479 T2 describes a red luminescent ink composition with a europium complex that is suitable for inkjets.

Further, WO 2008/065085 A1, WO 2010130681 A1 and WO 2014048702 A1 describe fluorescent inkjet inks that can contain rare earth chelates.

However, these have a light stability that is insufficient for certain security markings.

The object of the present invention is to remedy the disadvantages of the prior art.

This object is achieved by the combinations of features defined in the independent claims. Developments of the invention are the subject matter of the subclaims.

### SUMMARY OF THE INVENTION

1. (First aspect of the invention) An ink composition suitable for inkjet printing, comprising 0.001 wt.-% to 15 wt.-% of a rare earth complex of the formula

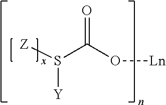

wherein ‘Ln’ represents one or several trivalent rare earth cations, chosen from the group consisting of Ce, Pr, Nd, Sm, Eu, Gd, Tb, Dy, Ho, Er, Tm and Yb, preferably selected from the group consisting of Eu, Gd and Tb, ‘n’ is preferably three,
‘S’ is a C₅-C₆ heteroaryl, preferably a pyridyl,
‘Y’ a diaza heterocycle, preferably an imidazolyl, particularly preferably a functionalized benzimidazolyl,
‘Z’ is either hydrogen or a functional group, chosen from the group consisting of alkyl, aryl, sulfonyl, and halogen,
‘x’=1 or any desired natural number.

2. (Preferred embodiment) The ink composition according to paragraph 1, which is light stable, in particular with a value according to the wool scale (“Wollskala”) that is greater than or equal to 6.

3. (Preferred embodiment) The ink composition according to paragraph 1 or 2, wherein the solubility is greater than 5 g/L in methyl ethyl ketone MEK and/or greater than 2 g/L in ethanol.

4. (Preferred embodiment) The ink composition according to any of the paragraphs 1 to 3, which is suitable for piezo printing.

5. (Preferred embodiment) The ink composition according to any of the paragraphs 1 to 4, which is suitable for thermal printing.

6. (Preferred embodiment) The ink composition according to any of the paragraphs 1 to 5, which is suitable for (particularly continuous) inkjet printing.

7. (Preferred embodiment) The ink composition according to any of the paragraphs 1 to 6, wherein the ink composition is based on a mixture of the central atoms.

8. (Second Aspect of the invention) Use of the ink composition according to any of the paragraphs 1 to 7 in a piezo printing process or a thermal process or a (particularly continuous) inkjet printing process.

9. (Third aspect of the invention) A printed product comprising a substrate printed with the ink composition of any of the paragraphs 1 to 7.

10. (Preferred embodiment) The printed product according to paragraph 9, wherein the substrate is a paper substrate or a plastic substrate.

### DETAILED DESCRIPTION OF THE INVENTION

Unless specified otherwise, percentage specifications are to be understood as weight percent (wt.-%).

The luminescent substances according to the invention have the following structural formula:

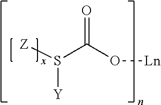

Therein ‘Ln’ is a trivalent rare earth cation selected from the group Ce, Pr, Nd, Sm, Eu, Gd, Tb, Dy, Ho, Er, Tm, Yb, or mixtures thereof, preferably ‘Ln’ is Eu, Gd or Tb.

‘n’ is preferably three.
‘S’ is a C₅-C₆ heteroaryl, preferably a pyridyl.
‘Y’ is a diaza heterocycle, preferably an imidazolyl, particularly preferably a functionalized benzimidazolyl.
‘Z’ is hydrogen or a functional group, for example alkyl, aryl, sulfonyl, halogen.

If several groups ‘Z’ are bound to ‘S’, these can be respectively the same or different. ‘x’ is zero or any desired integer.

Preferred Variants of ‘Y’:

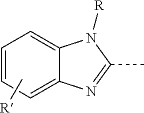

R or R′ are (mutually independently in each case) chosen from the group of hydrogen, alkyls, aryls, halogens, sulfonyls, esters, ethers, etc. In a preferred aspect R is an alkyl chain and Ln terbium. In a preferred aspect R is an aryl and Ln europium. In a preferred aspect, R′ is hydrogen or an alkyl group.

The complexes are characterized by high light stability and good solubility in common inkjet solvents (for example ethanol, methyl ethyl ketone (MEK)).

Preferably, the light resistance of the complexes according to the invention, measured as a press proof of an inkjet ink at print pressures suitable for the application (luminescence visible to the human eye; for determination of the wool scale (“Wollskala”) preferably 0.3 g complex per m² substrate), is greater than wool scale level 6. The determination of light resistance takes place here following ISO12040.

Preferably, the complexes according to the invention are readily excitable at 365 nm. Preferably, the complexes according to the invention have Eu as the central atom and an emission maximum at 612 nm+/−15 nm (red). Preferably, the complexes according to the invention have Tb as the central atom and an emission maximum at 544 nm+/−15 nm (green, several maxima). Preferably, the complexes according to the invention have Gd as the central atom and an emission maximum in the green (broad, ligand-dependent).

Preferably, the complexes according to the invention have a mixture of Eu and Tb in a certain ratio as central atoms, to produce a yellow or orange-colored mixed emission.

Preferably, the complexes according to the invention have a mixture of Eu and Gd (or Tb and Gd) in a certain ratio as central atoms. In a preferred embodiment, the ratio of the mixture of the two central atoms amounts to 0.5:1 to 1.5:1. A mixture of three central atoms (Eu, Gd, and Tb) can be used as well. The following cases are possible:

(a) A substantially complete energy transfer takes place from the Gd complexes to the Eu complexes (Tb complexes), so that less of the Eu complexes (Tb complexes) need to be employed in order to produce a similarly strong luminescence impression.
(b) A proportional/no energy transfer takes place from the Gd complexes to the Eu complexes (Tb complexes) and the Gd complexes emit the excitation energy in the form of a luminescence emission from excited energy levels of the ligand. In this case, a mixed luminescence is observed, for example yellow (through the red proportion of Eu complexes and the green proportion of Gd complexes).

Preferably, the solubility of the complexes according to the invention is greater than 2 g/L ethanol, particularly preferably 5 g/L.

Preferably, the solubility of the complexes according to the invention is greater than 5 g/L methyl ethyl ketone (MEK), particularly preferably 10 g/L.

Ink compositions according to the invention are preferably colorless, and thus invisible to the human eye without excitation of the fluorescence in the press proof.

Ink compositions according to the invention preferably contain: 0.001 to 15 wt.-% (weight percent) of the rare earth complex, particularly preferably 0.001 to 5 wt.-% (weight percent) rare earth complex. Not less than 50% of an organic solvent, preferably of an alcohol or ketone.

Common variants of inkjet systems are the continuous inkjet method and the drop-on-demand method. In the continuous inkjet method solvent-based inks with high fluidity are used and are continuously sprayed from the nozzles and the jet is deflected with an electrode. In the drop-on-demand method inks with a higher viscosity are utilized, which are sprayed from a nozzle chamber only upon demand.

The drop-on-demand method can be carried out with a “bubble jet” or “piezoelectric jet”. In the first case, the ink is brought to evaporation near the nozzle (also called thermal inkjet method), whereby a portion of the ink is pressed from the nozzle. In the second case a sudden pressure variation through a piezoelectric element causes the discharge of a portion of the ink from the nozzle.

In order to be suitable also for the thermal inkjet method, complexes according to the invention preferably possess a thermal stability (for example measured as a DSC (=differential scanning calorimetry) of the pure complex) of over 200° C., particularly preferably above 300° C.

Typical diameters of the nozzle openings in the drop-on-demand method are within a scale of 10-100 μm. For the continuous inkjet method typically larger nozzle openings are used in the range of 30-100 μm.

Ink formulations which are suitable for inkjet application must therefore ideally fulfill certain requirements, among other things in the fields of viscosity, solubility in detergents, compatibility with additives, wetting of the print substrate and electrical conductivity.

Further, the ink formulations should on the one hand dry rapidly on the substrate and on the other hand be able to flow through the nozzle openings and to remain therein, respectively, without clogging them. They should function largely independently of the orientation of the print head and be easily removable from the print head using corresponding detergents when required.

The ink compositions must therefore be formulated accordingly and are usually filtered with a filter in the range of 0.2-1 μm to prevent the presence of larger particles which could clog the nozzles.

Typical ingredients of an inkjet ink composition are organic or inorganic ingredients such as coloring agents (dyes, pigments), resins and binders, organic solvents, water, salts (in particular for adjusting the conductivity for the continuous inkjet method) and other additives.

The classification of the coloring agents into dyes or pigments takes place on the basis of the solubility in the medium used, wherein dyes are present in the solvent in a dissolved state and pigments are present in an undissolved state.

The resins and binders are certain polymers and solids, which are chosen appropriately depending on solubility in the ink composition and their effect in the dried printed film, respectively. They determine and improve, respectively, inter alia the adhesive properties on the substrate, for example on non-porous plastic surfaces. They further change the viscosity of the ink composition and thus determine, inter alia, the flow characteristics through the nozzles and the resulting droplet sizes. Further, they also significantly determine the resistance of the resulting printed film to mechanical influences (for example scraping off the print) or chemical influences (for example resistance to moisture or exposure to solvents).

Typical additives include:
plasticizers which render the dried printed film flexible and thereby improve adhesion and continuity of the printed film on the substrate;
dispersing agents which increase the dispersion of pigments and other particulate materials in the ink composition. The dispersing agents can act sterically and/or electrostatically, depending on their type and depending on their solubility and the polarity of the chosen solvent;
anti-corrosion agents which counteract the corrosive effect of certain salts added to increase the conductivity, for example of chlorides;
biocides, such as fungicides and bactericides, which prevent the spreading of micro-organisms and other organisms in aqueous inks;
buffers for regulating the pH value;
defoaming agents;
salts for adjusting the conductivity (in particular to achieve a sufficient deflection through the electrodes in the continuous inkjet method);
surface-active substances/surfactants which influence the wettability/penetration of the ink composition into the substrate. In particular substances which regulate the static or dynamic surface tension, since the impact size of the drops can be controlled thereby. This makes it possible to achieve a uniform diameter of impact size of the drops relatively independently of the type, purity and surface structure of the substrate.

Further, organic solvents are typically used for preparing an inkjet ink composition. These are, on the one hand, lowly viscous, highly volatile solvents as the major proportion, in order to facilitate the rapid drying of the printed image and to adjust a favorable viscosity in the range of 2 to 10 mPas. On the other hand, also more highly viscous, less volatile solvents are contained in a smaller proportion, in order to prevent the drying of the ink composition on the nozzle during printing pauses.

The highly volatile solvents are frequently ethanol or acetone; also methanol, 1-propanol, 2-propanol, methyl ethyl-ketone (MEK) and methyl isobutyl ketone are used frequently. Further suitable solvents are listed below.

The less volatile solvents, which slow down the drying, are frequently ketones, such as for example cyclohexanone, glycol ethers, ethers, acetals, such as dioxane or furan, dimethyl formamide, dimethyl sulfoxide, lactones, N-methylpyrrolidone, glycols, aliphatic hydrocarbons, and water. Further suitable solvents are listed below. To produce an ink composition having the respectively desired properties, advantageously individual or several of the highly volatile and less volatile solvents are combined in each case.

The desired properties of the solvent mixture employed include:
A volatility which is high enough that the ink composition dries quickly on the print substrate, but not so quickly that ink already dries in the printer, for example during the shutdown of the printing device.
A sufficient solubility for the binders and dyes employed.
A sufficient solubility to keep ionic species dissociated, if these are required to increase the conductivity in the continuous inkjet method.
A suitable viscosity for application with the respective printing device and substrate.

In a preferred aspect, the ink composition contains at least two different organic solvents, preferably at least three different organic solvents. The solvents are preferably chosen such that they can be mixed with one another over a wide range. The solvents can be polar or non-polar or a mixture of both. Examples of employable solvents are alcohols, polyols, amines, amides, esters, acids, ketones, ethers, water, as well as saturated and unsaturated hydrocarbons.

In particular when the resin/binder contains heteroatoms for hydrogen bonding/for ionic interactions, such as for example N and O, it is advantageous when the ink composition contains at least one polar solvent, in particular one or several protic solvents.

Examples of protic solvents are water, alcohols, polyols (such as alkane polyols with 2-12 carbon atoms and 2-4 hydroxyl groups, such as ethylene glycol, propylene glycol, butylene glycol, 1,3-propanediol, 1,3-butanediol, 1,4-butanediol, 2-methyl-2,4-pentanediol, glycerol, trimethylolpropane, pentaerythritol, etc.), polyalkylene glycols (for example polyalkylene glycols with 2-5 C₂₋₄ alkylene glycol units, such as diethylene glycol, triethylene glycol, tetraethylene glycol, dipropylene glycol, tripropylene glycol, etc.), partial ethers and esters of polyols and polyalkylene glycols (for example mono (C₁₋₆-alkyl) ethers and mono esters of polyols and polyakylene glycols with C₁₋₆-alkane carboxilic acids (for example ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether (DEGBE), ethylene glycol monoacetate, diethylene glycol monoacetate, etc.). Additionally or alternatively the ink composition can contain one or several hydrocarbons.

In one aspect, the ink composition contains at least two solvents, for example at least three solvents which are preferably chosen from the C₂₋₄-alkanols, C₂₋₄-alkanediols and glycerol. For example, the ink composition can contain ethanol, ethylene glycol and glycerol.

In a further aspect, the ink composition contains a C₁₋₄-monoalkyl ether of a C₂₋₄-alkanediol and/or of a polyalkylene glycol.

In a further aspect, the ink composition contains less than 5% water, for example less than 2% or less than 1% water, based on the total weight of the ink composition. For example, the ink composition can be substantially anhydrous.

Further examples of organic solvents which can be used as ingredient of the ink composition are N,N-dimethylformamide, N,N-dimethylacetamide, ethanolamine, diethanolamine, triethanolamine, trihydroxymethylaminomethane, 2-(isopropylamino)-ethanol, 2-pyrrolidone, N-methylpyrrolidone, acetonitrile, terpineols, ethylenediamine, benzyl alcohol, isodecanol, nitrobenzene and nitrotoluene.

When a solvent/a solvent combination is/are chosen for the ink composition, it is desirable to consider the requirements of the printing tool (with respect to viscosity and surface tension of the ink composition) and the surface properties of the substrate (for example hydrophilic or hydrophobic). In preferred ink compositions, in particular those which are adapted for inkjet printing with a piezo head, the viscosity of the composition (measured at 20° C.) amounts to not less than 2 mPas, for example not less than 5 mPas or not less than 8 mPas, and not more than 30 mPas, for example not more than 20 mPas or not more than 10 mPas. Preferably, the ink composition with respect to its viscosity behavior shows only a small temperature dependence in the range from 20° C. to 40° C., for example a temperature dependence of less than 0.4 mPas/° C.

Further, preferred ink compositions show a preferred surface tension (measured at 20° C.) of not less than 20 dynes/cm, for example not less than 25 dynes/cm, or not less than 30 dynes/cm, and not higher than 40 dynes/cm, for example not higher than 35 dynes/cm. In one aspect, the ink has a surface tension in the range of 25 dynes/cm to 55 dynes/cm.

Preferred additives are rheology modifiers and surfactants, for example SOLTHIX 250 or SOLSPERSE 21000 (both commercially available from Avecia Limited), styrene-allyl alcohol (SAA), ethyl cellulose, carboxymethyl cellulose, nitrocellulose, polyalkylene carbonates, ethyl nitrocellulose etc.

These additives can reduce the bleeding of the ink after application to the substrate.

Other additives are for example crystallization inhibitors, which control the crystallization of the printed film and the associated increase in film roughness after prolonged residence time or after treatment at elevated temperatures.

Suitable ink compositions of the present invention can for example be obtained by dissolving the rare earth complex in a liquid medium, preferably an alcoholic or ketonic solvent, and, optionally, by mixing thereof with ingredients which are usually contained in ink compositions, such as a binder resin (polyvinylpyrrolidone resins/polyvinyl resins/polyacrylate resins) and various types of surface-active agents.

The alcoholic (ketonic) solvent refers to a solvent which contains alcohol (ketones) as the main component. For example, the alcoholic solvent comprises a mixture of alcohol and water, when the mixture contains the alcohol as the main component. The main component refers to that component which is present in the solvent in an amount of not less than 50 wt.-%, preferably not less than 70 wt.-%.

Specific examples of the alcoholic solvent to be used in the ink compositions of the present invention include an aliphatic alcohol such as methanol, ethanol, propanol, isopropanol, and mixtures thereof. The alcoholic solvent can contain up to 30 wt.-%, preferably up to 10 wt.-%, water or can be substantially anhydrous. The combination amount of the alcoholic solvent to be mixed with the ink compositions preferably amounts to not less than 60 wt.-%, in other words, from 60 wt.-% up to the total remainder, with reference to the total weights of the ink compositions. More preferably, the combination amount of the alcoholic solvent amounts to 80 to 95 wt.-% with reference to the total weights of the ink compositions.

Further, for the purpose of improving the stability of the ink, or for preventing that the ink dries on the pen tip or a nozzle, an ether solvent such as ethylene glycol monomethyl ether, ethylene glycol monoethyl ether and propylene glycol monomethyl ether, a glycol solvent (a bivalent alcoholic solvent), such as ethylene glycol, diethylene glycol and propylene glycol, or a polyol, such as 1,2-hexanediol and 2,4,6-hexanetriol, can be added to the ink compositions of the present invention. The addition amount thereof preferably amounts to 0 to 30 wt.-%, with reference to the total weights of the ink compositions of the present invention.

The ink compositions of the present invention can optionally contain a ketone solvent, such as acetone, methyl ethyl ketone, methyl isobutyl ketone, cyclohexanone and 4-methoxy-4-methylpentanone, a hydrocarbon solvent, such as cyclohexane, methylcyclohexane, n-pentane, n-hexane and n-heptane, an ester solvent, such as ethyl acetate and n-propyl acetate, dimethyl sulfoxide, n-methyl-2-pyrrolidone, y-butyrolacetone, toluene, xylene, and a high-boiling petroleum solvent. These solvents are used alone or in combination of two or several.

The binder resin used for the ink compositions of the present invention is an ingredient which is used for good fixation of the luminescent compound to a recording material. As binder resin such a resin is used whose solubility in the above-mentioned solvent is satisfactory and with which the viscosity of the ink compositions can be adjusted in a suitable manner.

Specific examples of the preferred binder resins include resins which are listed below: a polyvinyl resin such as polyvinyl alcohol, polyvinyl butyral, polyvinylpyrrolidone, vinylpyrrolidone-vinyl-acetate copolymers; a polyamine resin, such as polyallylamine, polyvinylamine and polyethyleneimine; a polyacrylate resin, such as polymethyl acrylate, polyethylene acrylate, polymethyl methacrylate and polyvinyl methacrylate; and an amino resin, an alkyd resin, an epoxy resin, a phenol resin, a polyesterimide resin, a polyamide resin, a polyamide-imide resin, a silicone resin, a ketone resin, rosin, a rosin-modified resin (phenol, maleic acid, fumaric acid resin, etc.), a petroleum resin, a cellulose resin such as ethyl cellulose and nitrocellulose, and a natural resin (gum arabic, gelatin, etc.).

Particularly preferred binder resins include a polyvinyl resin, a polyacrylate resin, a polyamine resin, etc., which are usually used as ink for writing implements, as inkjet ink and printer ink. The combination amount of the binder resin to be mixed amounts for example to 0.5 to 30 wt.-%, preferably 1 to 20 wt.-%, with reference to the total weights of the ink compositions.

If a mixture of alcohol and water is used as the alcoholic solvent, some additives can be added: These include various types of surface-active agents (for example anionic, non-ionic and cationic surface-active agents such as alkylsulfate, phosphate and polyoxyethylene alkyl ether and alkylamine salt; ampholytic surface-active agents, fluorine-containing surface-active agents or surface-active agents of the acetylene glycol type), dispersing agents (for example rosin acid soap, stearic acid soap, oleic acid soap, sodium di-ß-naphthylmethane disulfate, sodium lauryl sulfate and sodium diethylhexyl sulfosuccinate), cyclodextrins (CD) (for example ß-CD, dimethyl-ß-CD, methyl-ß-CD, hydroxyethyl-ß-CD, and hydroxypropyl-ß-CD), or defoaming agents. These additives can be used in an amount of 0.1 to 5 wt.-%, preferably of 1 to 3 wt.-%, with reference to the ink compositions.

In the embodiments, the ligands 1-6 are used by way of example. These names refer to the structures, which are broken down in the following table.

| Structure | Name |
|---|---|
| 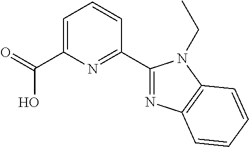 [SMILES: CCn1c(-c2cccc(C(=O)O)n2)nc2ccccc21] | Ligand 1 |
| 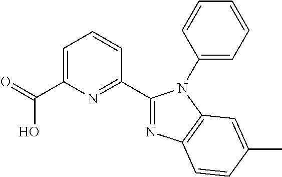 [SMILES: Cc1ccc2nc(-c3cccc(C(=O)O)n3)n(-c3ccccc3)c2c1] | Ligand 2 |
| 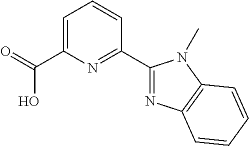 [SMILES: Cn1c(-c2cccc(C(=O)O)n2)nc2ccccc21] | Ligand 3 |
| 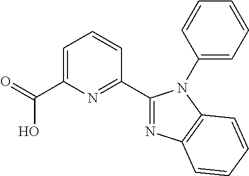 [SMILES: O=C(O)c1cccc(-c2nc3ccccc3n2-c2ccccc2)n1] | Ligand 4 |
| 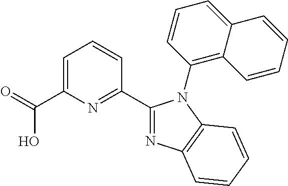 [SMILES: O=C(O)c1cccc(-c2nc3ccccc3n2-c2cccc3ccccc23)n1] | Ligand 5 |
| 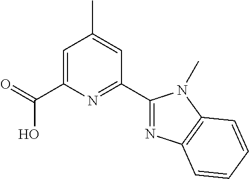 [SMILES: Cc1cc(C(=O)O)nc(-c2nc3ccccc3n2C)c1] | Ligand 6 |

### Embodiment Example 1

In a beaker (beaker 1) 4.23 g ligand 1 (15.85 mmol) are stirred in 250 ml ethanol. To the mixture 0.634 g sodium hydroxide (15.85 mmol), dissolved in 10 ml water, are added dropwise while stirring. In a second beaker (beaker 2) 1.97 g terbium(III) chloride hexahydrate (5.27 mmol) are dissolved in 50 ml water. This solution is dripped into the beaker 1 while stirring. The obtained mixture is boiled for 2 hours under reflux and then poured into 750 ml water. The solution is cooled to room temperature and the complex is isolated by filtration.

Half a gram of complex 1 was dissolved in a solution of 90 g ethanol and 5 g ethylene glycol, and 4 g polyvinylpyrrolidone [PVP K-15 (trade name) manufactured by IPS K. K.] were added to the to prepare the ink composition. Using an inkjet recording apparatus [HG5130 manufactured by Seiko Epson Corp.], the print of a bar code was carried out on standard paper. When the printed material was irradiated with ultraviolet light (365 nm) using a black light lamp, an intensive, brilliant green light emission was observed.

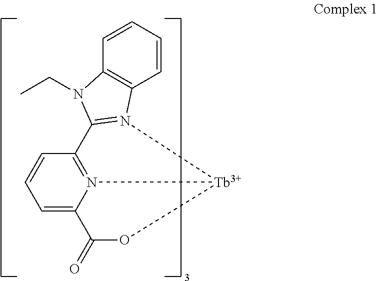

### Embodiment Example 1b

The above embodiment example is repeated, but instead of 5.27 mmol terbium(III) chloride hexahydrate a mixture of 2.635 mmol terbium(III) chloride hexahydrate and 2.635 mmol europium(III) chloride hexahydrate is used. The resulting proof now possesses an intensive yellow light emission.

### Embodiment Example 2

In a beaker (beaker 1) 5.21 g ligand 2 (15.85 mmol) are stirred in 250 ml ethanol. To the mixture 0.634 g sodium hydroxide (15.85 mmol), dissolved in 10 ml water, are added dropwise while stirring. In a second beaker (beaker 2) 0.97 g europium (III) chloride hexahydrate (2.635 mmol) and 0.98 g gadolinium(III) chloride hexahydrate (2.635 mmol) are dissolved in 50 ml water. This solution is dripped into the beaker 1 while stirring. The obtained mixture is boiled for 2 hours under reflux and subsequently poured into 750 ml water. The solution is cooled to room temperature and the complex is isolated by filtration.

One gram of complex 2 was dissolved in a solution of 90 g ethanol and 5 g ethyl acetate, and 5 g alcohol-soluble nitrocellulose (CA4 A10 from Bergerac) were added to prepare the ink composition. Using an inkjet recording apparatus [HG5130 manufactured by Seiko Epson Corp.] the print of a bar code was carried out on standard paper. When the printed material was irradiated with ultraviolet light (365 nm) using a black light lamp, an intensive, brilliant red light emission was observed.

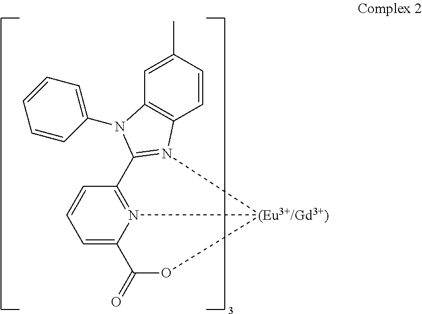

### Embodiment Example 3

In a beaker (beaker 1) 4.01 g ligand 3 (15.85 mmol) are stirred in 250 ml ethanol. To the mixture 0.634 g sodium hydroxide (15.85 mmol), dissolved in 10 ml water, are added dropwise while stirring. In a second beaker (beaker 2) 1.97 g terbium(III) chloride hexahydrate (5.27 mmol) are dissolved in 50 ml water. This solution is dripped into the beaker 1 while stirring. The obtained mixture is boiled for 2 hours under reflux and subsequently poured into 750 ml water. The solution is cooled to room temperature and the complex is isolated by filtration.

Half a gram of complex 3 was dissolved in a solution of 90 g ethanol and 5 g ethylene glycol, and 4 g polyvinylpyrrolidone [PVP K-15 (trade name) manufactured by IPS K. K.] were added to prepare the ink composition. Using an inkjet recording apparatus [HG5130 manufactured by Seiko Epson Corp.] the print of a bar code was carried out on standard paper. When the printed material was irradiated with ultraviolet light (365 nm) using a black light lamp, an intensive, brilliant green light emission was observed.

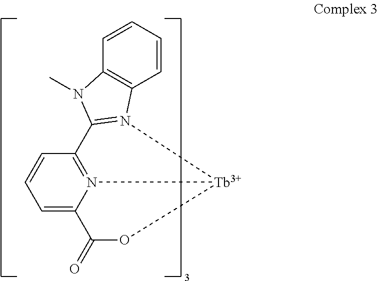

### Embodiment Example 4

In a beaker (beaker 1) 5 g ligand 4 (15.85 mmol) are stirred in 250 ml ethanol. To the mixture 0.634 g sodium hydroxide (15.85 mmol), dissolved in 10 ml water, are added dropwise while stirring. In a second beaker (beaker 2) 1.93 g europium(III) chloride hexahydrate (5.27 mmol) are dissolved in 50 ml water. This solution is dripped into the beaker 1 while stirring. The obtained mixture is boiled for 2 hours under reflux and subsequently poured into 750 ml water. The solution is cooled to room temperature and the complex is isolated by filtration.

One gram of complex 4 was dissolved in a solution of 95 g methyl ethyl ketone (MEK) and 5 g diethylene glycol, and 5 g vinyl resin (VMCH from Union Carbide) were added to prepare the ink composition.

Using an inkjet recording apparatus [HG5130 manufactured by Seiko Epson Corp.] the print of a bar code was carried out on standard paper. When the printed material was irradiated with ultraviolet light (365 ran) using a black light lamp, an intensive, brilliant red light emission was observed.

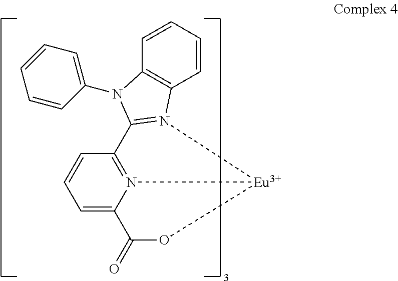

### Embodiment Example 5

In a beaker (beaker 1) 5.79 g ligand 5 (15.85 mmol) are stirred in 250 ml ethanol. To the mixture 0.634 g sodium hydroxide (15.85 mmol), dissolved in 10 ml of water, are added dropwise while stirring. In a second beaker (beaker 2) 1.93 g europium(III) chloride hexahydrate (5.27 mmol) are dissolved in 50 ml water. This solution is dripped into the beaker 1 while stirring. The obtained mixture is boiled for 2 hours under reflux and subsequently poured into 750 ml water. The solution is cooled to room temperature and the complex is isolated by filtration.

Half a gram of complex 5 was dissolved in a solution of 70 g MEK and 20 g ethanol, and 5 g vinyl resin (VMCH from Union Carbide) were added to prepare the ink composition. Using an inkjet recording apparatus [HG5130 manufactured by Seiko Epson Corp.] the print of a bar code was carried out on standard paper. When the printed material was irradiated with ultraviolet light (365 nm) using a black light lamp, an intensive, brilliant red light emission was observed.

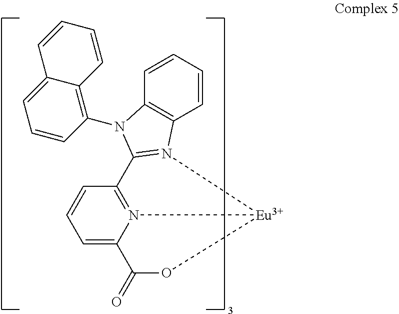

### Embodiment Example 6

In a beaker (beaker 1) 4.23 g ligand 6 (15.85 mmol) are stirred in 250 ml ethanol. To the mixture 0.634 g sodium hydroxide (15.85 mmol), dissolved in 10 ml water, are added dropwise while stirring. In a second beaker (beaker 2) 1.97 g terbium(III) chloride hexahydrate (5.27 mmol) are dissolved in 50 ml water. This solution is dripped into the beaker 1 while stirring. The obtained mixture is boiled for 2 hours under reflux and subsequently poured into 750 ml water. The solution is cooled to room temperature and the complex is isolated by filtration

Half a gram of complex 6 was dissolved in a solution of 90 g ethanol, 3 g diethylene glycol and 2 g glycerol, and 5 g polyamide resin (Eurelon 975 from Schering) were added to prepare the ink composition.

Using an inkjet recording apparatus [HG5130 manufactured by Seiko Epson Corp.] the print of a bar code was carried out on standard paper. When the printed material was irradiated with ultraviolet light (365 nm) using a black light lamp, an intensive, brilliant green light emission was observed.

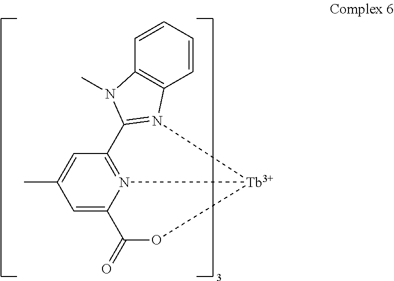

1.-10. (canceled)

11. An ink composition suitable for inkjet printing, comprising 0.001 wt.-% to 15 wt.-% of a rare earth complex of the formula 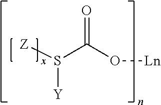
wherein ‘Ln’ represents one or several trivalent rare earth cations, chosen from the group consisting of Ce, Pr, Nd, Sm, Eu, Gd, Tb, Dy, Ho, Er, Tm and Yb,
‘n’ is three,
‘S’ is a C₅-C₆ heteroaryl, preferably a pyridyl,
‘Y’ is a diaza heterocycle, including an imidazolyl, and/or a functionalized benzimidazolyl,
‘Z’ is either hydrogen or a functional group, chosen from the group consisting of alkyl, aryl, sulfonyl, and halogen, ‘x’=1 or any desired natural number.

12. The ink composition according to claim 11, which is light stable, with a value according to the wool scale that is greater than or equal to 6.

13. The ink composition according to claim 11, wherein the solubility is greater than 5 g/L in methyl ethyl ketone MEK and/or greater than 2 g/L in ethanol.

14. The ink composition according to claim 11, which is suitable for piezo printing.

15. The ink composition according to claim 11, which is suitable for thermal printing.

16. The ink composition according to claim 11, which is suitable for continuous inkjet printing.

17. The ink composition according to claim 11, wherein the ink composition is based on a mixture of the central atoms.

18. Use of the ink composition according to claim 11 in a piezo printing method or a thermal printing method or a continuous inkjet printing method.

19. A printed product, comprising a substrate printed with the ink composition according to claim 11.

20. The printed product according to claim 19, wherein the substrate is a paper substrate or a plastic substrate.
